(19) United States
(12) Patent Application Publication
(10) Pub. No.: US 2013/0074015 A1
(43) Pub. Date: Mar. 21, 2013

(54) SYSTEM TO SCROLL TEXT ON A SMALL DISPLAY SCREEN

(71) Applicants: PAUL WILLIAM WATKINSON, LIFTON (GB); GREGORY WILLIAM WATKINSON, LIFTON (GB)

(72) Inventors: PAUL WILLIAM WATKINSON, LIFTON (GB); GREGORY WILLIAM WATKINSON, LIFTON (GB)

(21) Appl. No.: 13/622,087

(22) Filed: Sep. 18, 2012

Related U.S. Application Data
(60) Provisional application No. 61/536,784, filed on Sep. 20, 2011.

(51) Int. Cl. G06F 3/033

(52) U.S. Cl. 715/863

(57) ABSTRACT

The present invention is a system to scroll text on a small display screen that includes a screen finger sensor that detects when a selected one of a user's finger and a stylus is dragged across the small display screen and a page, sets a scroll speed, will scroll to an edge of the page and move down a sentence and repeat to scroll, reaches a bottom of the page and will move to a first sentence of a next consecutive page. The system also includes a logic controller that detects the text is displayed and sets the screen finger sensor to await activation of the system and is typically a software module or a downloaded app.

This application claims priority to U.S. Provisional Application 61/536,784 filed on Sep. 20, 2011, the entire disclosure of which is incorporated by reference.

### TECHNICAL FIELD & BACKGROUND

Smaller mobile devices such as smartphones can sometimes be difficult to read because of the relatively small display screen on a smaller mobile device. Because of this relatively small display screen, often all of the words in a sentence, paragraph or page cannot be displayed on or fit on the relatively small screen simultaneously.

It is an object of the present invention to provide a system to scroll text on a small display screen that enables a user to read a page of text, a photograph or a drawing on a relatively small display screen that is smaller than the page of text, the photograph or the drawing with fewer touches on the small display screen.

It is an object of the present invention to provide a system to scroll text on a small display screen that allows a user to use their finger or stylus to drag a page on a relatively small display screen that is smaller than the page to initiate scrolling the page without changing a zooming capability on the page.

It is an object of the present invention to provide a system to scroll text on a small display screen that allows a user to use their finger or stylus to set a scrolling speed with their finger or stylus to drag a page on a relatively small display screen that is smaller than the page that allows a user to use their finger or stylus to set a scrolling speed with their finger or stylus to drag a page on a relatively small display screen that is smaller than the page.

What is really needed is a system to scroll text on a small display screen that enables a user to read a page of text, a photograph or a drawing on a relatively small display screen that is smaller than the page of text, the photograph or the drawing with fewer touches on the small display screen that allows a user to use their finger or stylus to drag a page on a relatively small display screen that is smaller than the page to initiate scrolling the page without changing a zooming capability on the page.

### BRIEF DESCRIPTION OF THE DRAWINGS

The present invention will be described by way of exemplary embodiments, but not limitations, illustrated in the accompanying drawing in which like references denote similar elements, and in which:

FIG. 1 illustrates a front environmental perspective view of a system to scroll text on a small display screen, in accordance with one embodiment of the present invention.

FIG. 2 illustrates a block diagram of a system to scroll text on a small display screen, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is utilized repeatedly. The phrase generally does not refer to the same embodiment, however, it may. The terms “comprising”, “having” and “including” are synonymous, unless the context dictates otherwise.

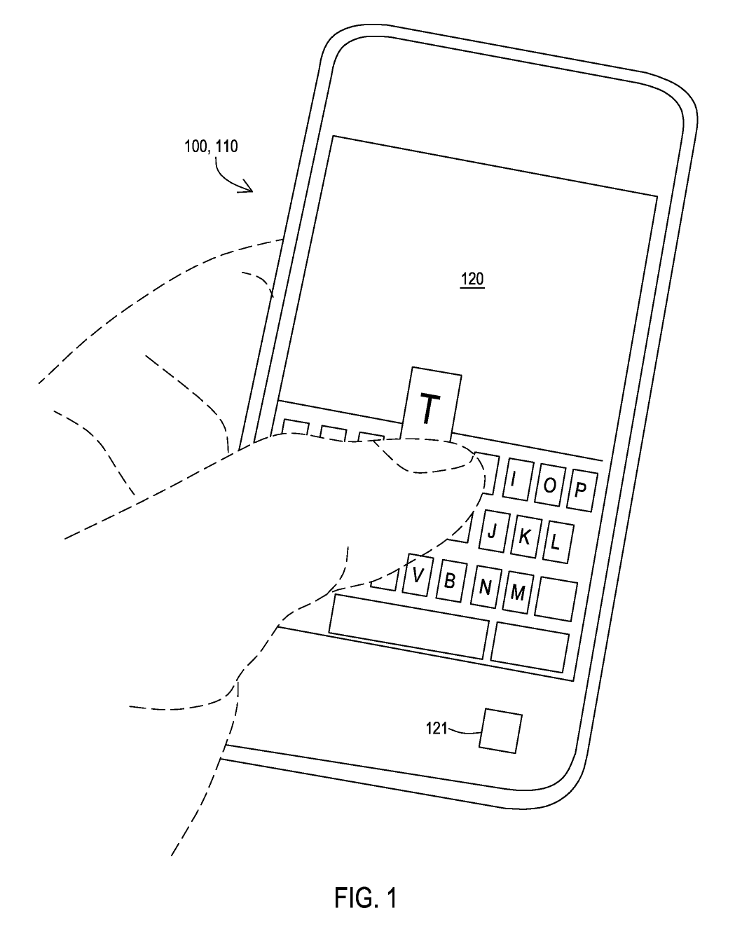

FIG. 1 illustrates a front environmental perspective view of a system 100 to scroll text on a small display screen, in accordance with one embodiment of the present invention. The system 100 is illustrated with a smartphone 110 and a relatively small display screen 120. The system 100 resides on the smartphone 110 and can reside on any suitable smartphone operating system 121 such as an iOS 5 made by Apple Computer, Inc. in Cupertino, Calif. or mobile device with a relatively small display screen.

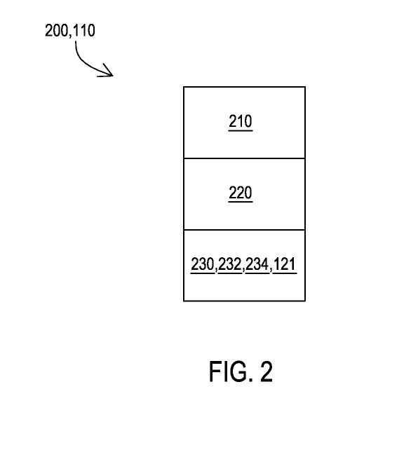

FIG. 2 illustrates a block diagram of a system 200 to scroll text on a small display screen 210, in accordance with one embodiment of the present invention. The system 200 and relatively small display screen 210 illustrated and described in FIG. 2 is similar to the system 100 and small display screen 120 illustrated and displayed in FIG. 1. The system 200 can reside on a smartphone (FIG. 1, 110) or on any suitable type of smartphone or mobile device with a relatively small display screen.

FIG. 2 additionally includes a screen finger sensor 220 and a logic controller 230. The screen finger sensor 220 detects when a user's finger or a stylus is dragged across the relatively small display screen 210. The scrolling from the screen finger sensor 220 leaves a zoom capability of the page being scrolled unaffected. The speed at which the user's finger or stylus is dragged across the small display screen 210 sets a scroll speed or starts the page scrolling at a predefined speed. The user's finger or stylus will then scroll to the edge of the page and then move down a sentence and repeat scrolling. When the user's finger or stylus reaches the bottom of the page it will move to the first sentence of the next consecutive page. To stop the scrolling, the small display screen 210 is tapped once. When text is displayed, a two finger tap on the small display screen 210 will automatically activate zoom and scroll to a predefined setting, which is set by the user. The system 200 automatically scrolls a page of text to assist reading the page, while other traditional systems simply allow a user to continually drag their finger, mouse or stylus across the small display screen 210 to move the page so that it can be read. The logic controller 230 detects that text is being displayed and will set the screen finger sensor 220 to await activation. The logic controller 230 can be a software module 232 that resides on the smartphone operating system 121 or suitable mobile device or the logic controller 230 can be a downloadable app 234 that is downloaded onto the smartphone operating system 121 or suitable mobile device.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A system to scroll text on a small display screen, comprising:
a screen finger sensor that detects when a selected one of a user's finger and a stylus is dragged across said small display screen and a page; and
a logic controller that detects said text is displayed and sets said screen finger sensor to await activation of said system.

2. The system according to claim 1, wherein said screen finger sensor leaves a zoom capability unaffected.

3. The system according to claim 1, wherein a speed that said selected one of a user's finger and a stylus is dragged across said small display screen sets a scroll speed.

4. The system according to claim 3, wherein said scroll speed that said selected one of a user's finger and a stylus is dragged across said small display screen and said page scrolls at a predefined speed.

5. The system according to claim 1, wherein said selected one of a user's finger and a stylus will scroll to an edge of said page and move down a sentence and repeat to scroll.

6. The system according to claim 1, wherein said small display screen is tapped once to stop to scroll.

7. The system according to claim 1, said small display screen will automatically activate zoom and scroll to a predefined setting with a two finger tap when said text is displayed.

8. The system according to claim 1, wherein said selected one of a user's finger and a stylus reaches a bottom of said page, said selected one of a user's finger and a stylus will move to a first sentence of a next consecutive page.

9. The system according to claim 1, wherein said system resides on a smartphone.

10. The system according to claim 9, wherein said system resides on a smartphone operating system.

11. The system according to claim 10, wherein said logic controller is a software module that resides on said smartphone operating system.

12. A system to scroll text on a small display screen, comprising:
a screen finger sensor that detects when a selected one of a user's finger and a stylus is dragged across said small display screen and a page, wherein a speed that said selected one of a user's finger and a stylus is dragged across said small display screen sets a scroll speed, said selected one of a user's finger and a stylus will scroll to an edge of said page and move down a sentence and repeat to scroll, said selected one of a user's finger and a stylus reaches a bottom of said page and said selected one of a user's finger and a stylus will move to a first sentence of a next consecutive page; and
a logic controller that detects said text is displayed and sets said screen finger sensor to await activation of said system.

13. The system according to claim 12, wherein said screen finger sensor leaves a zoom capability unaffected.

14. The system according to claim 12, wherein said scroll speed that said selected one of a user's finger and a stylus is dragged across said small display screen and said page scrolls at a predefined speed.

15. The system according to claim 12, wherein said small display screen is tapped once to stop to scroll.

16. The system according to claim 12, said small display screen will automatically activate zoom and scroll to a predefined setting with a two finger tap when said text is displayed.

17. The system according to claim 12, wherein said system resides on a smartphone.

18. The system according to claim 17, wherein said system resides on a smartphone operating system.

19. The system according to claim 18, wherein said logic controller is a software module that resides on said smartphone operating system.

20. The system according to claim 18, wherein said logic controller is a downloadable app that is downloaded onto said smartphone operating system.
